(19) United States
(12) Patent Application Publication
(10) Pub. No.: US 2014/0224740 A1
(43) Pub. Date: Aug. 14, 2014

(54) PREPARATION OF PRE-COATED RP-ROTORS AND UNIVERSAL CHROMATOROTORS, CHROMATOGRAPHIC SEPARATION DEVICES AND METHODS FOR CENTRIFUGAL PREPARATIVE CHROMATOGRAPHY

(71) Applicants: Muhammad Ilias, Oxford, MS (US); Volodymyr Samoylenko, Jupiter, FL (US); Van Douglas Gillum, Memphis, TN (US)

(72) Inventors: Muhammad Ilias, Oxford, MS (US); Volodymyr Samoylenko, Jupiter, FL (US); Van Douglas Gillum, Memphis, TN (US)

(21) Appl. No.: 14/343,830

(22) PCT Filed: Sep. 7, 2012
(86) PCT No.: PCT/US2012/054220

§ 371 Date: Apr. 10, 2014

Related U.S. Application Data
(60) Provisional application No. 61/532,649, filed on Sep. 9, 2011.

(51) Int. Cl. B01D 15/02

(52) U.S. Cl. CPC B01D 15/02
USPC 210/658; 210/198.3

(57) ABSTRACT

Reversed phase solid silica gel sorbent layers which can adhere with appropriate binders to a solid surface were developed. Pre-coated RP-rotors of different thickness were used These pre-coated RP-rotors can be used for Centrifugal Preparative Thin-layer Chromatography (CPTLC) using any appropriate device for Centrifugal Chromatography, like Chromatotron® or Cyclograph. Organic compounds including very polar ones can be separated and/or purified in a preparative scale from mixtures by these pre-coated RP-rotors, using different solvent systems. Also described is a new chromatographic separating device (hereinafter Chromato Rotor) and a method for separation of constituents from natural products or mixture of organic compounds using a centrifugal preparative chromatographic instrument with a separating element which contains a binder free sorbent layer packed or loaded between two supporting rotors and retained from moving outside by a porous filter. Only eluants pass through. ChromatoRotors with different sorbents with different dimensions and capacity can be prepared and used for centrifugal chromatographic separation. Virtually any classes of organic compounds including very polar natural products can be separated or purified from a mixture by using these rotors due to the unlimited combination of sorbents and mixture of mobile phases, including but not limited to aqueous-based solvents. These plates can also be used for CPTLC using any appropriate device for Centrifugal Chromatography like Chromatotron® or Cyclograph® instruments.

### FIELD OF THE INVENTION

This invention relates to the field of centrifugal chromatography which uses a circular plate(s)/rotor(s) coated with a sorbent such as reverse phase (RP)silicon dioxide (RP SiO₂) using an appropriate binder or loaded with a sorbent (binder free) in a centrifugal chromatographic device without the use of a binder (binder-free). In another aspect, the invention relates to a method of preparation of RP SiO₂ solid layers and other sorbents adhered or bound to glass plate(s)/rotor(s) for Centrifugal Preparative Thin-layer Chromatography. In another aspect, the invention also relates to method of chromatographic separation of the components of a mixture by means of the circular plate(s)/disc(s) coated or filled with a sorbent as a layer using a centrifugal chromatographic device (Chromatorotor

### BACKGROUND OF THE INVENTION

Liquid chromatography, generally, relates to the separation of a single component(s) from a multi-component mixture by moving the component mixture through an adsorbent, which interacts with liquid mobile phase, by means of capillary action [thin-layer chromatography (TLC)], gravity [column chromatography (CC)], pressure [high pressure liquid chromatography (HPLC)] or centrifugal forces generated by high speed rotation [centrifugal chromatography (CPTLC)].

In late 1940, the evolution of classical chromatography, so called axial flow chromatography, led to appearance of radial chromatographic technology, introduced by Hopf [1]. In this device, called “the chromatofuge”, the concept and method was adopted to separate compounds by centrifugal forces [1]. The method and apparatus was later modified for adsorption chromatography [2-5]. However, these apparatus and methods have a number of limitations, such as using a paper as a sorbent, poor performance for separations requiring volatile solvents, low capacity, etc. The apparatus and its application described by Heftmann [6], in fact, reproduce Hopf's work [1]. Both apparatus do not allow visual control of the chromatography process due to solid metal used in construction. Besides, the ratio of disc diameter to its height is ca. 3-6, which is not enough to eliminate the influence of gravitational forces on the chromatographic process. Moreover, the presence of metals and polypropylene as the construction materials sets tight limitations on the use of only unaggressive media, which are unable to degrade these materials.

In general, the method of centrifugal chromatography is suitable for separating both natural [7, 8] and synthetic compounds [9, 10].

Centrifugal chromatographic devices have been known in the prior art. A centrifugal liquid chromatograph in which a pair of discs are rotatably arranged in vertically spaced relationship, and a separating medium is filled in the space defined therebetween, so that a mobile phase may make ingress into the stationary phase due to centrifugal force, is described in U.S. Pat. No. 4,077,886 [11]. The solvent is introduced through a developer supply pipe used for feeding the developer space on the upper part of discs. A limitation of this device is that the solvent has to be constantly supplied into the “developer space” above the discs to keep that space filled with the solvent as in the case of classical column chromatography. This requires a complex and precise construction to provide a tight seal during rotation of the device. In addition, special measures are required to balance input and output flow of the solvent, which vary depending on rotation speed, adding further construction complications.

Another U.S. Pat. No. 3.417,548 [12] discloses the use of closely spaced discs for gas chromatography. An apparatus for continuous liquid chromatography with a disc shaped rotating chamber divided into separate sub-cavities is described in U.S. Pat. No. 3,527,350 [13]. U.S. Pat. No. 3,617,557 [14] discloses a method and apparatus for preparative centrifugation chromatography where the sorbent body is arranged between two annular plates. Under the influence of Coriolis forces, different separated components come to different regions of the rim of the disc. Cups are used to receive eluate from discrete regions of the rim. A separation method carried out on a disc of paper or gel under the dual influence of centrifugal and electrical forces was reported in U.S. Pat. No. 3,395,093 [15].

A planar centrifugal chromatographic device inclined to the horizontal line in which a glass rotor as a flat disk, mounted within a chamber, was described in U.S. Pat. No. 4,139,458 [16]. The adsorbing medium is arranged on the upper side of the rotor. An inner wall of the chamber, which is inclined toward the axis of the rotor at an angle of less than 90° with respect to the upper side of the rotor, forms the collecting device. The solvent is introduced onto the upper surface of the adsorbing medium near the shaft of the rotor. The solvent flows through the adsorbing medium under the action of centrifugal force, which causes the chromatographic separation. The solvent exits from the adsorbing medium, together with the separated substance, at the edge of the circular glass disk and moves, due to the centrifugal force, into the collecting device, which is constructed in the stationary chamber. The solvent flows, under the action of gravity, to the lowermost point of the inclined chamber, where it is removed from the device through an output.

A disadvantage of a planar centrifugal chromatographic device is that the significant turbulence caused by disk rotation does not permit the establishment of a stable vapor space with a defined composition. This has the result that a part of the solvent does not flow through the adsorbing medium, but instead evaporates and is removed—not fulfilling its task as a solvent. This fact reduces the reproducibility and efficiency of the separation. A further disadvantage of this design is that the adsorbing medium must be glued onto the glass plate and, hence, be secured from spilling out of the disk. Thus, only an adhesive adsorbing medium such as silica gel or alumina sorbents can be used. So far, this technology has not been fully utilized for preparative scale isolation and purification of different classes of organic compounds and secondary metabolites (especially for polar compounds) due to the unavailability of RP SiO₂ coated rotors.

Finally, a planar centrifugal chromatographic device was reported in which a motor driven rotor is arranged in a chamber, and a collecting device arranged very close to the outer edge of the rotor, but within the chamber (U.S. Pat. No. 4,678,570 [17]). A rotor of this device consists of a lower support plate, an upper cover plate and an adsorbing medium disposed between the two plates and has the inventive characteristics that the thickness of the adsorbing medium increases from outer to inner edge.

Currently two companies supply commercially available instruments for centrifugal chromatography; T-Squared Technology, Inc. (previously, Harrison Research Inc.) which distributes the Chromatotron® [16, 18], and Analtech Inc. which distributes the Cyclograph® [19]. Both instruments utilize the same physical principal of centrifugal chromatography, i.e. chromatography developed by centrifugal forces in a thin layer of sorbent coated on a circular glass or plastic plate or rotor, in addition, both instruments are designed for the preparative scale separation of compounds primarily on silica gel or alumina sorbents. However, using only silica gel or alumina as a sorbent significantly limits the types of compounds separable by this method, as well as the nature and composition of the solvent systems used for the separation, it is a well-known fact that polar or very polar compounds like glycosides, anthocyanidines, polyphenols, quaternary alkaloids, and sugars are not separable, or only separable with great difficulty and/or with very low yields, using silica gel or alumina as chromatographic sorbents. In addition, the water based solvents or solvents containing acids cannot be used in the prior art methods since they destroy the binder used to bind the silica gel or alumina sorbents to the plates. Gypsum (CaSO₄), the binder used for preparation of both silica gel and alumina rotors, is slightly soluble in water or acid, and eventually it will be washed out from the plate during elution. This significant drawback was realized by Analtech, who tried to develop RP coatings and without success. They stated in their Operations Manual [18] (p. 5) for CycloGraph: “Reversed phase coatings have been experimented with for over ten years with very little success. The best layer created could only be used once before it fell prey to cracking. Since this is the most highly requested layer by customers it is still under development”. At the same time the Instruction Manual for Chromatotron® [19] (pp. 1 and 20) further stated that “The Chromatotron was designed for preparative separations on silica gel and alumina. It is not useful for chromatography requiring cellulose or reversed phase sorbents” and “Satisfactory binders for C18 silica gel and other hydrophobic sorbents are not available”. Although there is a report of a procedure for converting silica gel layers with starch binder into reversed phase (RP) C18 layers [7], that development was not released to the public and is not to our knowledge used commercially.

Therefore, despite a great demand for RP C18 coated rotors (discs), the prior art of the centrifugal chromatography technology does not provide a solution of producing RP C18 silica gel containing chromatographic rotors (discs) for the utilization in commercially available instruments such as the Chromatotron and Cyclograph instruments. The same statement applies to a chromatographic separating device with a sorbent of any nature except regular silica gel or alumina.

There remains a need for effective technology for centrifugal chromatography especially for polar natural products or synthetic compounds, which produces a good separation in a short time, good resolution, requires low amount of solvent(s), and provides a wide choice of different mobile phases and different solvents.

### SUMMARY OF THE INVENTION

In the present invention, the shortcomings of the prior art for a centrifugal chromatographic separating device containing different sorbents including sorbents, for separating polar compounds are achieved; and significant advantages, heretofore unrealized, are achieved. It is an object of the present invention to make a stable, uniform and solid RP silica gel sorbent layer with ability to adhere to solid surfaces like glass. Another object of the present invention is to determine appropriate binder(s) able to adhere or bind RP silica gel particles together and to glass surface, as well as not washed out by water based solvents. A further object of the present invention is to provide the ability to visualize the separation for the RP sorbent layer under short- and long wave UV lights, it is also an object of the present invention to make a stable chromatographic separating device (i.e., a circular plate, rotor or disc; a “Chromatorotor”) containing a layer of a binder free sorbent material. Another object of the present invention is to provide a method for centrifugal chromatographic separation of the components of a mixture using abovementioned chromatographic separating device in centrifugal chromatography instruments. This invention specifically can be applicable in the commercially available instruments for Centrifugal Chromatography such as Chromatotron® or Cyclograph® instruments.

In the present invention, the input flow of the solvent can vary over a wide range and doesn't rely on output flow of the solvent; because the present centrifugal chromatographic system does not need any “developer space” for solvents. U.S. Pat. No. 4,077,886 [11] doesn't disclose the nature of material used for the preparation of their pair of discs, or how to replace/refill the discs, or whether it is attachable or detachable, which was used in the said centrifugal chromatographic device. Furthermore, the abovementioned U.S. Pat. No. 4,077,886 [11] doesn't disclose the nature of the sorbent or provides any examples of the successful employment of their device for the separation of various types of compounds. Whereas the present invention is constructed with UV transmittable glasse, is adjustable (that is disc thickness is changeable according to sample load), detachable, and re-packable with all kinds of binder free sorbents. The discs are also reusable. Finally, the present invention can be monitored visually or with UV light to follow the progress of the separation of compounds of interest.

An embodiment of the present invention comprises a circular glass disc with a reversed phase (RP) silica gel sorbent coated on its upper surface. An appropriate ratio of corresponding binder, reversed phase RP silica gel, fluorescent indicators and nature of vehicle to prepare free flowing slurry is used to ensure mechanical and chemical stability, uniformity, sufficient resolution, and convenient visualization when the rotor is used for CPTLC at any centrifugal chromatography devices, either Chromatotron® or Cyclograph®.

Another embodiment of the present invention comprises a chromatographic separating device (i.e., a ChromatoRotor) containing a layer of a binder-free sorbent material packed between two circular discs attached to each other and supported from moving outside by porous filter allowing only liquids or eluant to pass through. ChromatoRotors with different sorbents, including but not limited to normal silica gel (SiO₂) (including silica gel modified with functional groups and/or chiral groups), reversed phase silica gel (including RP-Si0₂ modified with functional groups and/or chiral groups), alumina, polyamide, and gel filtration resins (e.g. Sephadex®). Different dimensions and capacities can be prepared and used fur centrifugal chromatographic separation. Optionally, fluorescent indicator(s) and/or other additives can be added to sorbent layer(s), which should ensure mechanical and chemical stability, uniformity, sufficient resolution, and convenient visualization when the disc is used for centrifugal chromatographic separation at any centrifugal chromatography instruments, either Chromatotron® or Cyclograph®. An advantage of the present invention is the use of a transparent or semi-transparent top circular disc made with mechanically and chemically stable material, which is able to withstand the high centrifugal forces and chemical solvents typically used in liquid chromatography. Such materials can be chemically resistive glass, quartz or plastic (e.g. Teflon®) and the like.

### BRIEF DESCRIPTION OF THE DRAWINGS

FIG. 1—Table 1, Composition of recipes used to prepare rotors using different experiments.

FIGS. 2A-2F—The edges of a standard glass rotor are taped, The slurry is distributed evenly right after placing it into the glass rotor surface, The slurry is solidified uniformly after 48 h of air drying, The plate is cut to 2 mm layers, The 2 mm plate is mounted to Chromatotron, and The 2 mm plate is washing with acetone.

FIG. 3—The structures of the compounds isolated by centrifugal chromatography using pre-coated RP-rotors and ChromatoRotors.

FIG. 4—Sectional view of an annular separation element according to Design 1. All measurements are given in mm,

FIG. 5—Sectional view of an annular separation element according to Design 1. All measurements are given in mm.

FIG. 6—Sectional view of an annular separation element according to Design 2. All measurements are given in mm.

FIG. 7—Sectional view of an annular separation element according to Design 2. All measurements are given in mm.

FIGS. 8A-8G—The lower plate (2) (i.e., glass disc) with a porous filter (4) (i.e., sintered Teflon® filter) and support elements (5) (i.e., Teflon washers) mounted, The lower (2) and upper (3) plates (i.e., glass discs) with a porous filter (4) (i.e., sintered Teflon® filter) and support elements (5) (i.e., Teflon washers) assembled by means of screws (6), The chromatographic separating device (3 mm) charged with RP C18 silica gel according to Design 2, The chromatographic separating device (3 mm), according to Design 2, is mounted to a Chromatotron, A porous fitter (4) (i.e., sintered Teflon® filter). Support elements (5) (i.e., Teflon® washers). Screws (6) made of stainless steel

FIG. 9—Separation of fraction BCDV-C2F-80-81 (300 mg) using custom made 3 mm RP C18 silica gel chromatorotor. TLC ran on RP C18 plate using acetone: H₂O=7:3 solvent and observed under UV 254 nm, showing clear separation of the two compounds with very close R_{f} values.

FIG. 10—Separation of fraction BCDV-C2F-80-81 (300 mg) using custom made 3 mm RP C18 silica gel chromatoplate. TLC ran on RP C18 plate using acetone: H₂O=7:3 solvent and observed under UV 366 nm, showing clear separation of the two compounds with very close R_{f} values.

FIG. 11—Separation of column fraction (180 mg) from Fagonia cretica EtOH extract using custom made 3 mm RP C18 silica gel chromatorotor. TLC ran on RP C18 plate using methanol:H₂O=7:3 solvent and visualized by 1% vanillin-H₂SO₄ spray reagent showing clear separation of Saponin glycosides (8) (fractions 93120) and (9) (fractions 205-250)

### DETAILED DESCRIPTION OF THE INVENTION

The separation and purification of polar chemical compounds, plant or marine-derived secondary metabolites and pharmaceutical drugs are substantially reliant upon the reversed phase sorbents such as solid RP SiO₂) using various separation technologies such as column chromatography (CC) and high-pressure liquid chromatography (HPLC). These technologies have many advantages and limitations over other chromatographic techniques in terms of diverse application, resolution of separation, yields and costs. The principal of column chromatographic separation relied on adsorption, gravitational force and partition, while HPLC is driven primarily by pressure. CC has shortcomings for the separation of chemical compounds, analogs or diastereoisomers which have close R_{f} values in a mixture. While HPLC has limited preparative capabilities and executing a repeated preparative scale separation by HPLC is not reproducible and also very expensive. On the other hand, the principle of centrifugal chromatography (using Chromatotron® or Cyclograph®) is based on centrifugal force generated by high speed rotation, in addition to adsorption, partition and gravity. This unique combination allows fast and efficient preparative-scale separation and purification of organic compounds with close R_{f} values or even for stereo isomeric mixtures. Furthermore, it requires less solvent and sorbent for separation work and therefore, could be a potential application of “Green Chemistry”. Unfortunately, this technology has so far not been fully utilized for many classes of compounds due to the unavailability of reversed phase SiO₂ and other non-silica gel sorbent containing discs.

Applicants have used the centrifugal chromatographic technology extensively for the regular and preparative scale isolation and purification of various classes of compounds (such as alkaloids, terpenoids, flavonoids, aromatic compounds, phenolic compounds, semi polar glycosides etc.) using silica gel and/alumina sorbent coated rotors. [20-27]. With this experience and background, the preparation of an improved chromatographic separating device containing RP silica gel sorbent (as well as other sorbents) was initiated.

Using the existing general guidelines and procedures as depicted in Chromatotron Instruction Manual [18] for the preparation of silica/alumina sorbent rotors, several recipes were initially developed using RP-silica gel sorbent by trial and error, and then rigorously tested. Since the RP-coated rotors will be used in Chromatotron® or Cyclograph® instruments, a standard glass rotor currently designed was selected for this purpose. Initially, applicants' challenge was to select a correct RP silica gel sorbent with the appropriate and desired porosity (simulated with those recommended for silica gel or alumina for the preparation of coated rotors for Chromatotron). Based on those assumptions a column grade RP material was selected for this purpose. Applicants' second challenge was to select binder(s) for coating RP material to a glass rotor/plate, which can be mounted and should be stable enough for Chromatotron use. It is important that the binders should not be washed out by water-based vehicles, commonly used for the elution of RP sorbents. Applicants' third challenge was to select a vehicle or mixture of vehicles for the preparation of slurry, since the RP column grade sorbent generally floats in water (i.e., un-wettable by water) when it is used as a vehicle, making it necessary to use an organic solvent mixable or compatible with water to make free flowing slurry of the recipe. Applicants' fourth challenge was to add fluorescent indicator(s) to detect or visualize the movement of organic compounds under short and long wave UV lights during the separation in a Chromatotron. Finally, it was also applicants' challenge to set the required conditions right for air and oven drying of the coated RP sorbent. Initially, several single regular binders or glues [including gypsum, white multi-purpose glue (e.g. Elmer's® glue), and silicate glue were tried and tested for the preparation of RP slurry, but they failed to produce required adherence of the sorbent layer to the glass rotors, as well as intra-particle binding of RP sorbent. Generally, a single binder with RP sorbent had generated cracks (when gypsum was used) or loosely bound among the RP particles and between sorbent and glass (when Elmer's/silicate glues was used) after drying the coated rotors. Therefore, a combination of two binders was selected based on one binder for binding RP sorbent particles among themselves, and the other binder for binding RP sorbent with glass rotor. This technique improved the binding capability of the RP coated sorbent among particles and with glass rotor.

### Developing Recipe, Sorbent Layers and Their Preparation for RP Coated Rotors

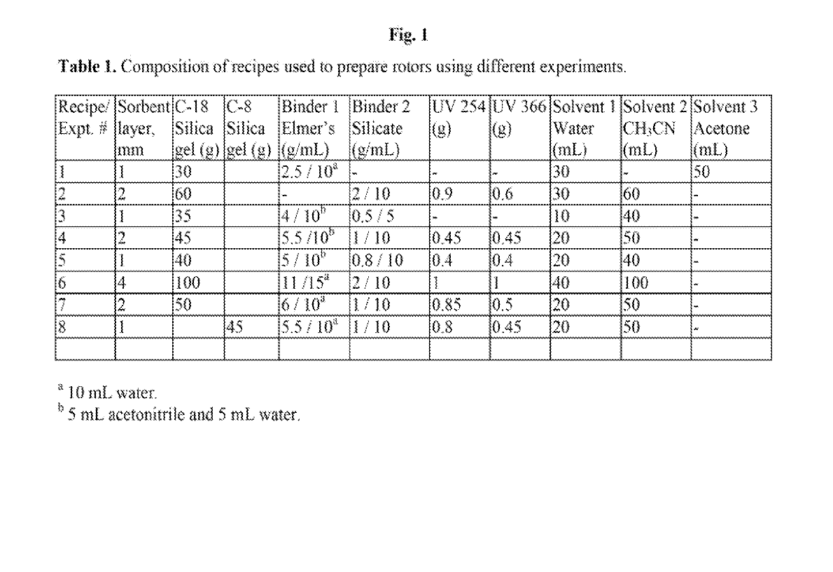

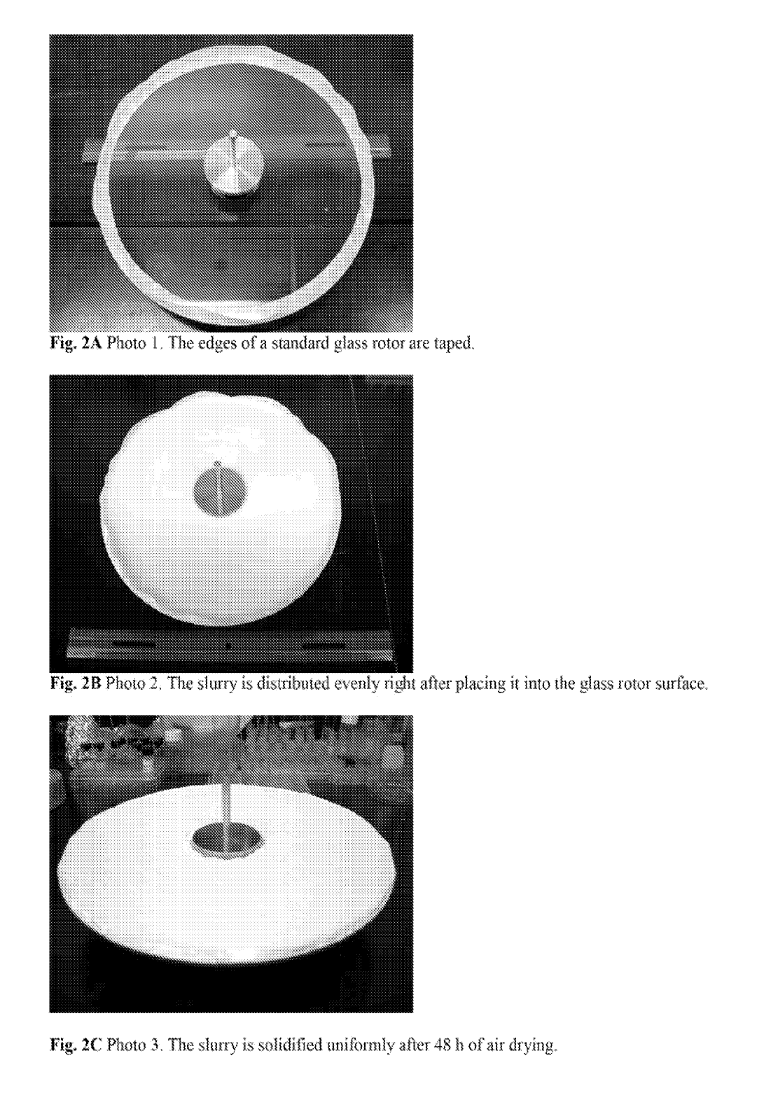

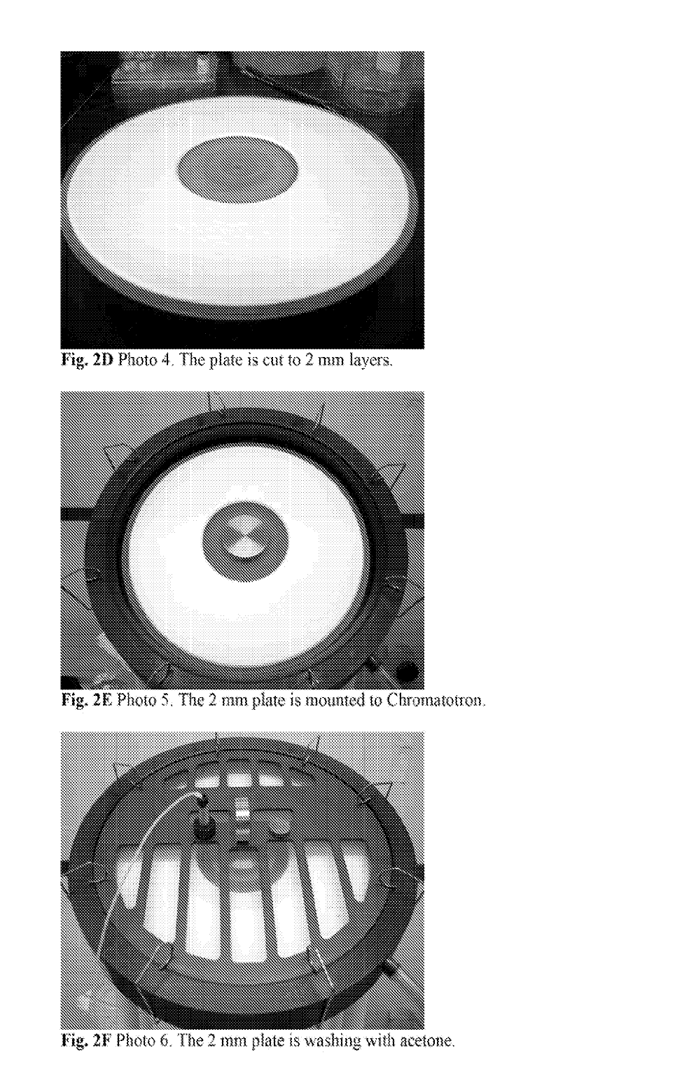

Sorbent layers with 1 mm thickness are designed for the separation of small samples, up to 250 mg of mixtures of compounds (preferably 3-4 compounds), and 2 mm layers for larger sample loads, up to 500 mg total sample. The resolving power of 1 mm layers is significantly superior to those of 2 mm layers when resolving compounds with close R_{f} values. On the other hand, 4 mm thick sorbent layers are for relatively large loads, up to about 1-2 g, used generally for purification or cleaning of large amounts of single compounds from organic synthesis or extracts, and/or pre-fractionation of crude plant extracts. Considering the above challenges, eight experiments were conducted with different recipes (FIG. 1, Table 1) for the preparation of pre-coated RP-rotors with different thickness by trial and error as described in the Experimental Section. Recipes 1 and 2 consist of RP C18 sorbent and one binder (Elmer's or Silicate glue), recipe 3 contain RP C18 sorbent, two binders (Elmer's and Silicate glues), recipes 4-7 contain RP C18 sorbent, two binders (Elmer's and Silicate glues) and two fluorescent indicators (for UV 256 and 366 nm) in different proportions, and finally recipe 8 contain RP C8 sorbent, two binders (Elmer's and Silicate glues) and two fluorescent indicators (for UV 256 and 366 nm). Photos 1-6 (FIGS. 2A-2F) visually represent crucial steps of the pre-coated RP-rotors preparation procedures.

Recipes 1 and 2 with a single binder (Elmer's or silicate glue) failed to generate a RP coated plate, while recipes 3-7 with two binders (Elmer's+silicate glues) worked very well to generate a final product. Slurries were prepared using a vehicle containing 20-50% acetonitrile in water. This eliminated the flotation of RP-silica gel sorbent in the aqueous vehicle. Slurries were spread manually on the glass rotors generally according to the instructions depicted in the Chromatotron manual [18], and then adjusted according to nature of distribution of slurries on the rotor (for details see Recipes 5-7). It was observed that the consistency of the free flowing slurry is critical for the success of the final RP coated rotors, and subsequent cutting of the activated plate. The rotor coated with slurry was kept 48 hours for air drying at room temperature, and once it was dried (i.e., no visible vehicle on the rotor or not a moist rotor), the rotor was placed in the oven for drying, initially at low temperature (70-80° C.) and then slow increment of temperatures up to 100° C. Once dried, the RP coated sorbent layers was subjected to cutting manually using commercially available scrapper blades and other tools (Analtech, Inc.), RP-coated rotors of 1 mm, 2 mm and 4 mm were scrapped very carefully, with continuous clock-wise rotation of the scrapper.

### Separation and Purification of Compounds Using RP Coated Rotors

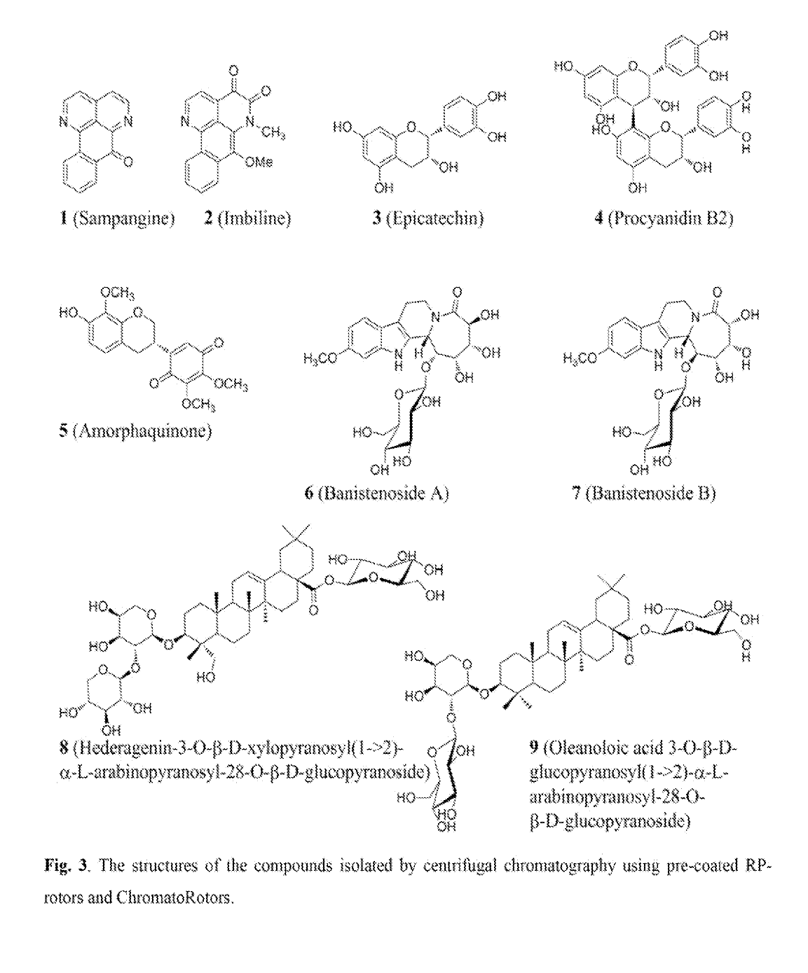

Using recipes 5-7 (FIG. 1, Table 1), several rotors with 1, 2, and 4 mm thickness were prepared, and used for the separation of mixtures of 1-aza-aporphine alkaloids and proanthocyanidines. A RP TLC analysis of an alkaloidal mixture, and a proanthocyanidin mixture revealed two colored spots in each case using water-MeCN as developing solvent. Using a 1 mm pre-coated RP-rotor with fluorescent indicators, a mixture of sampangine (1) and imbiline (2) (FIG. 3) was applied for separation by using aqueous based solvent (10% water/MeCN). After saturating the rotor, sample was applied via the solvent pump, and the mixture was eluted with aqueous based solvent, namely water:acetonitrile (1:9). A red colored band (imbiline) was separated from a yellow colored band (sampangine) on the rotating rotor, which was also observed under long wave UV light as two distinct fluorescent bands. Elution with 50 ml of solvent mixture eluted imbiline, followed by sampangine, collected in a fraction collector. Compounds were pooled accordingly by RP TLC analysis.

In a second experiment, epicatechin (3) and procyanidin B2 (4) (FIG. 3), two polar proanthocyanidins, were separated by a 2 mm pre-coated RP-rotor, using different solvent mixture and a similar method as described above. Epicatechin (3) and procyanidin B2 (4) were separated as two fluorescent bands observed by long wave UV light and eluted as pure compounds. After each experiment, plates were washed, dried/activated and regenerated. No serious damage was noticed on these plates.

In order to prepare pre.-coated rotors containing binder free sorbents, another approach was conceptualized to simplify sorbent packing by eliminating the binder entirely and minimizing various steps of the preparation of pre-coated rotors bound to glass. The object of this invention describes a new chromatographic separating device (i.e., a ChromatoRotor) and a method of separation using this device. Since the plates can be used in Chromatotron® or Cyclograph® instruments, a standard glass plate currently designed for these instruments was selected as a starting point for the purpose of our technology. The idea was to incorporate/add/pack a sorbent layer between two plates in such a way so there will be no need for a binder to hold a sorbent layer within a separating device. At the same time, ChromatoRotor can virtually be used with any type of sorbent, is reusable, easily adjustable to required capacity (mostly from 1 to 6 mm thickness), and is mechanically and chemically stable. An ability to visual monitor (under regular light and/or UV light) the chromatographic separation is an additional feature of the invention. The invention includes the use of different sorbent materials, including different grades. Different thicknesses of the sorbent may be used according to the nature of the sample to be separated, the scale of separation required and so forth.

The present invention is described in the detailed description appearing above and which follows, in reference to the figures by way of non-limiting examples of embodiments of the present invention, in which like reference numerals represent similar parts throughout the several views of the drawings. The particulars shown herein are provided by way of example and for purposes of illustrative discussion of the embodiments of the present invention only, and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the figures making it apparent to those skilled in the relevant art how the several forms of the present invention may be embodied and used in practice.

### Design 1.

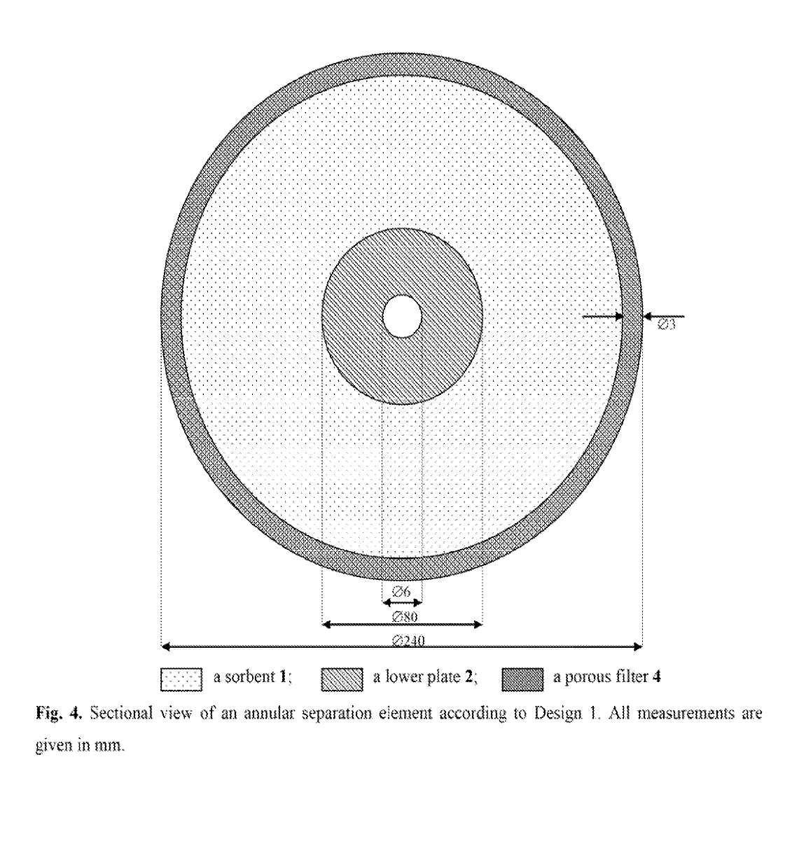

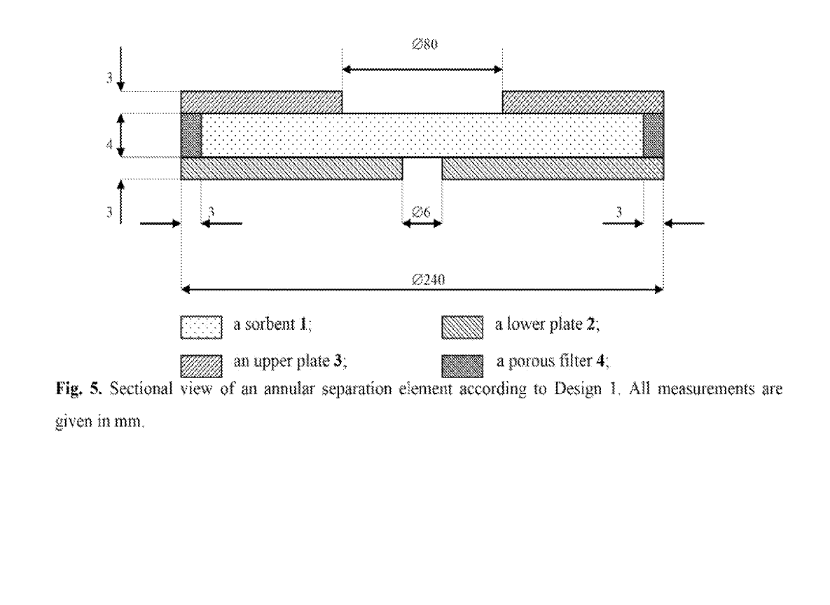

A sorbent layer 1 is sandwiched between a lower annular plate/disc 2 and a corresponding upper annular plate/disc 3 (FIG. 4-5). These two plates constitute a support of the sorbent layer 1. Rotors with different sorbents, including but not limited to normal silica gel (SiO₂) including silica gel modified with functional groups and/or chiral groups, reversed phase silica gel including RP-silica gel modified with functional groups and/or chiral groups, alumina, polyamide, Sephadex resins, etc., with different dimensions and capacity can be prepared and used for centrifugal chromatographic separation. Optionally, fluorescent indicator(s) and/or other additives can be added to a sorbent layer 1. Both plates 2 and 3 are made of mechanically and chemically stable material, which is able to withstand high centrifugal forces (i.e., rotation of Chromatotron® or Cyclograph® instruments) and chemical solvents (for example, organic solvents, water, acidic or basic solutions) usually used for liquid chromatography. However, the upper plate 3 should be made of transparent or semi-transparent material to ensure visual control of a chromatographic process. Such material can be, for example, chemically resistive glass, quartz or plastic (e.g., Teflon®) etc. In order to prevent a layer of a sorbent material 1 from moving outside, a porous filter 4 is arranged at the outer edge of an annular separation device, to allow only liquids to pass through the porous filter. Optionally, a porous filter 4 is arranged at the inner edge of an annular separation device. The porous filter 4 may consist of thin porous metal, plastic, fiber, glass or other chemically resistant materials, for example, sintered stainless steel or sintered Teflon®. The porous filter 4 can be glued to plates 2 and 3 with chemically resistant glue. The porous filter 4 can also be fused in plates 2 and 3. Optionally, at least three additional support elements 5 are arranged between plates 2 and 3 to prevent a collapse of plates 2 and 3 in case a porous filter 4 is made of flexible material. Usually the support elements 5 may have a small size and different shape, so it doesn't prevent a normal course of a chromatographic process, but stable enough to keep a constant distance between the surfaces of plates 2 and 3. The support elements 5 should be made of chemically resistant material. An upper plate 3 has a central opening and enables sample to be supplied to the sorbent layer 1. A solvent can be supplied through the same opening of upper plate 3. The sorbent layer 1 is usually packed in situ by pouring (under rotation) it into the space between discs 2 and 3 in the form of slurry. The sorbent layer 1 can also be packed inside discs 2 and 3 in dry form. The sorbent 1 is removable and replaceable by whatever material is appropriate for the chromatographic separation. However, this design has an imperfection that capacity of the separation device is defined by the height of the porous filter 4 or/and the support elements 5 and cannot be changed for the given separation element.

FIGS. 4 and 5 are sectional views of a representative annular separation device according to this design.

### Design 2.

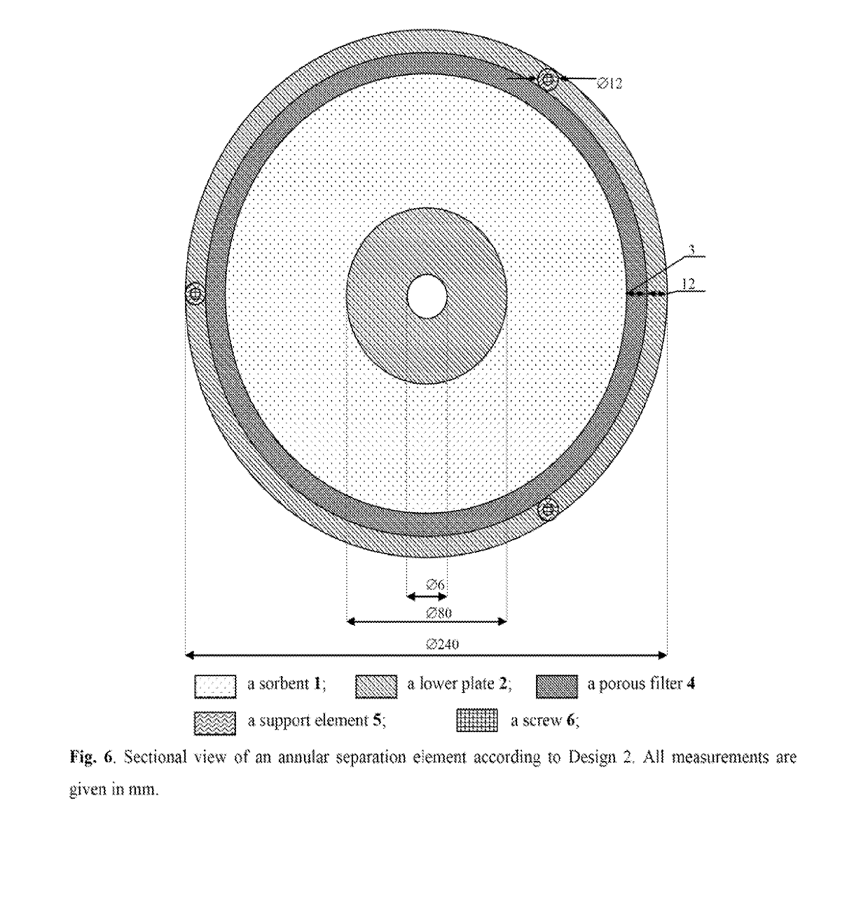

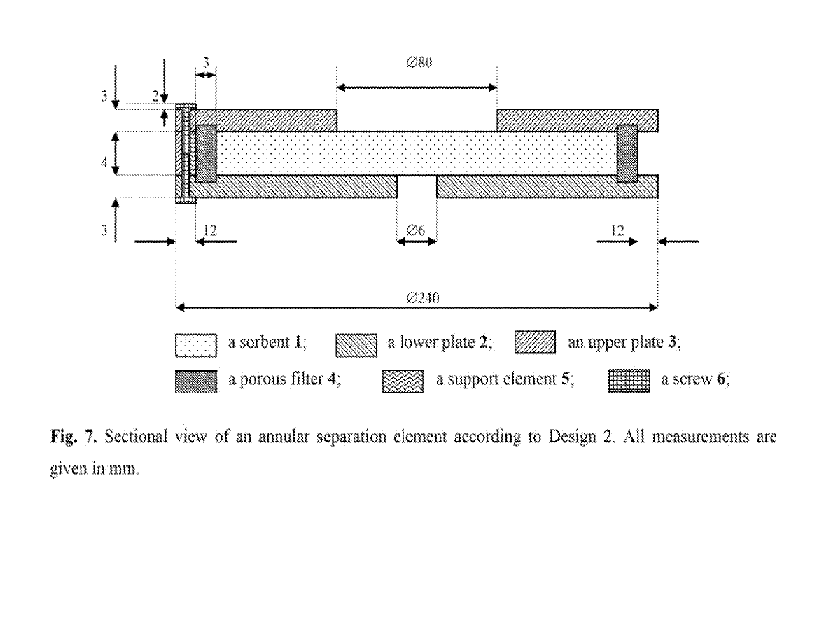

A sorbent layer 1 is sandwiched between a lower annular plate/disc 2 and a corresponding upper annular plate/disc 3 (FIG. 6-7). These two plates constitute a support of the sorbent 1. Rotors with different sorbents, including but not limited to normal silica gel (SiO₂) including silica gel modified with functional groups and/or chiral groups, reversed phase silica gel including RP-silica gel modified with functional groups and/or chiral groups, alumina, polyamide, Sephadex resins, etc., with different dimensions and capacity can be prepared and used for centrifugal chromatographic separation. Optionally, fluorescent indicator(s) and/or other additives can be added to a sorbent layer 1. Both discs 2 and 3 are made of mechanically and chemically stable material, which is able to withstand high centrifugal forces and chemical solvents usually used for liquid chromatography (same as design 1). However, the upper disc 3 should be made of transparent or semi-transparent material to ensure visual observation of a chromatographic separation process. Such material can be, for example, chemically resistant glass, quartz or plastic (like Teflon®) etc. In order to retain a layer of a sorbent material 1 from moving outside a porous filter 4 is arranged at the inner edge of an annular separation device, allowing only liquids to pass through. Optionally, a porous filter 4 is arranged at the inner edge of an annular separation device. The porous filter 4 may consist of thin porous metal, plastic, fiber, glass or other chemically resistant materials, for example, sintered stainless steel or sintered Teflon®. Both discs 2 and 3 are fixed together by means of screws 6. Optionally, at least three additional support elements 5 are arranged between discs 2 and 3 to prevent a collapse of plates 2 and 3 in case a porous filter 4 is made of flexible material. Usually the support elements 5 may have a small size and different shape, so it doesn't prevent a normal course of a chromatographic process, but stable enough to keep a constant distance between the surfaces of discs 2 and 3. The support element 5 should be made of chemically resistant material. An upper disc 3 has a central opening and enables sample to be supplied to the sorbent 1. A solvent can be supplied through the same opening of upper plate 3. The sorbent layer 1 is usually packed in situ by pouring (under rotation) it into the space between discs 2 and 3 in the form of slurry. The sorbent layer 1 can also be packed inside plates 2 and 3 in dry form. The sorbent 1 is removable and replaceable by whatever material is appropriate for the chromatographic separation. This design allows easily change a capacity of the given separation element by replacing a porous filter 4 and if necessary, replacing also support elements 5.

FIGS. 6 and 7 are sectional views of a representative annular separation device according to this design.

### Developing Recipe, Sorbent Layers and Their Preparation for ChromatoRotors

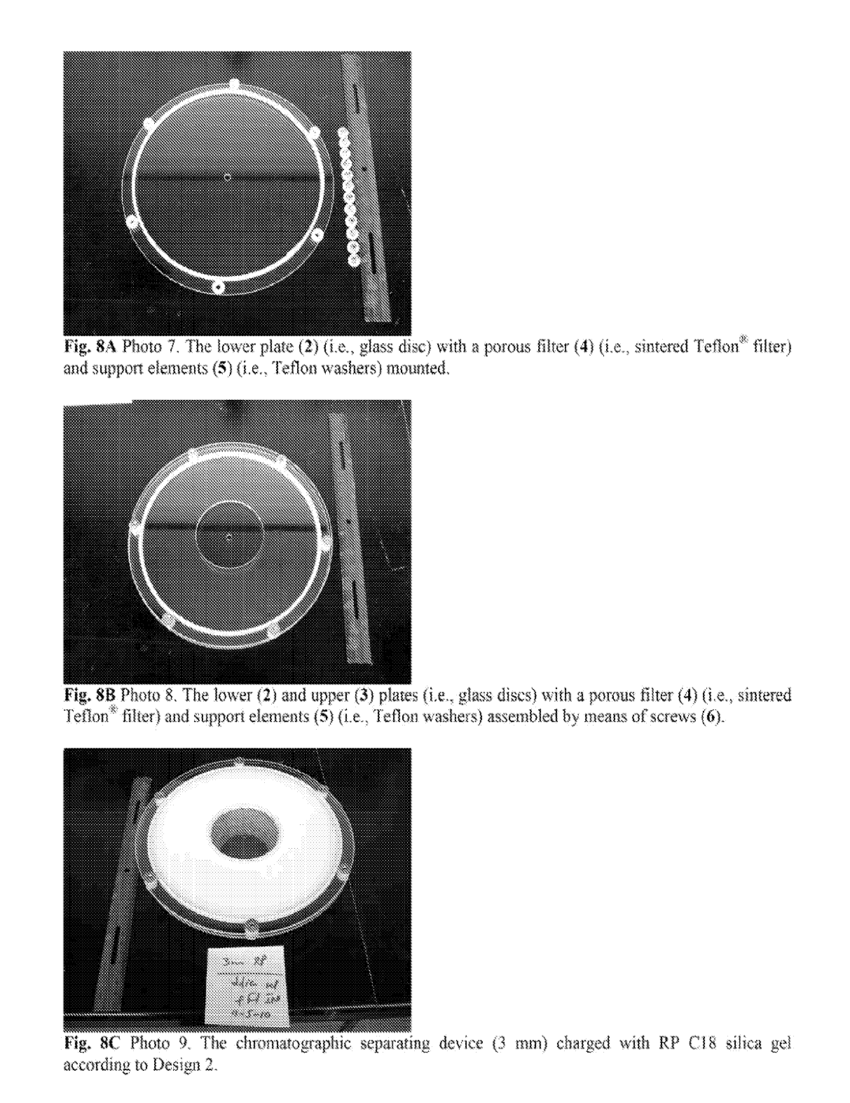

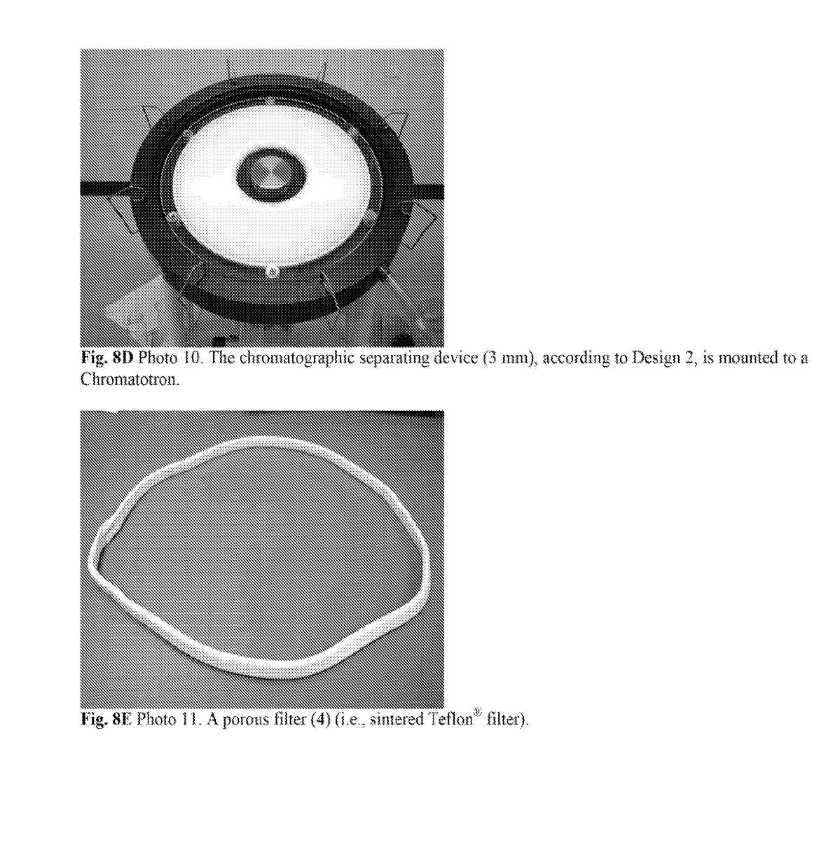

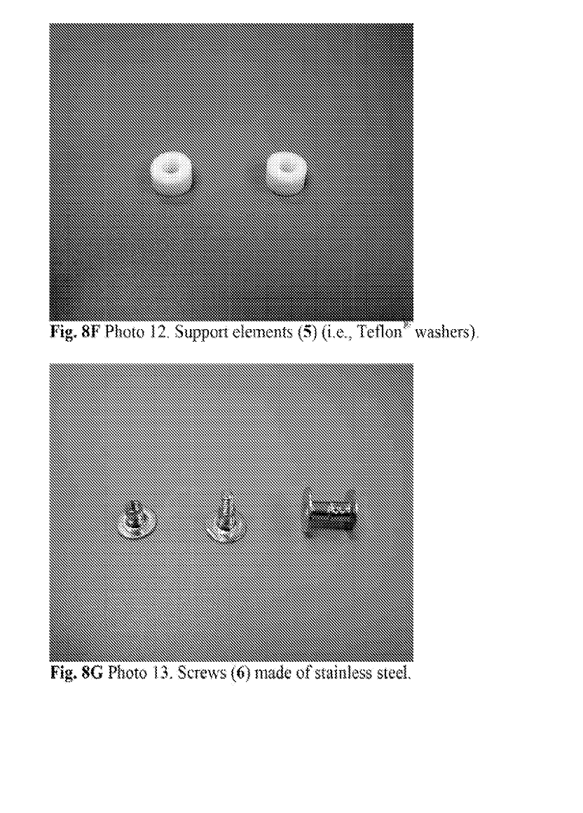

Sorbent layers with 1 or 2 mm thickness are designed for the separation of small samples, up to 250 mg of mixtures of compounds (preferably 3-4 compounds), and 2 or 3 mm layers for larger sample loads, up to 500 mg total sample. The resolving power of 1 mm layers is superior to those of 2 mm layers when resolving compounds with close R_{f} values. On the other hand, 4-6 mm thick sorbent layers are for relatively large loads, up to about 1-3 g, used generally for purification or cleaning of large amounts of single compound from organic synthesis or extracts, and/or pre-fractionation of crude plant extracts. Considering the above diversity, a number of experiments were conducted for the centrifugal chromatographic separation with ChromatoRotors of different design, capacity, sorbents, solvents as describe in Experimental section. Photos 7-13 (FIGS. 8A-8G) visually represent crucial steps of the assembling and parts required for ChromatoRotors.

### EXPERIMENTAL

### General Experimental Procedures and Supplies

Centrifugal preparative chromatography using Chromatotron®, Harrison Research Inc. (currently T-Squared Technology, Inc.), Model 8924, tagged with a fraction collector (CF-2, Spectrum Chromatography) was carried out using commercially available solvents (Fisher Scientific) and their mixtures as eluants. Silica gel Octadecyl (C₁₈) from J. T. Baker (7025-01, BAKERBOND®, 40 μm) and silica gel Octyl (C₈) from J. T. Baker (7026-00, BAKERBOND®, 40 μm) were used as a sorbents. Elmer's Glue-All multipurpose glue distributed by Elmer's Products, Inc., USA, (from general store) and the silicate glue (The Science Company, USA) (www.sciencecompany.com, CS-S1136, Lot #81-0034-020810, technical grade) were used as binders for C18 silica get. Fluorescent indicators UV254 (cat. #81671) and UV366 (cat. #81672) manufactured by Macherey-Nagel Inc., Germany, (www.mn.net.com) were used as indicators for visualization. Fisher Scientific sonicator (FS110D) was used during RP-silica gel slurry preparation. Liquid samples after chromatography were dried by means of Savant Speed Vac Plus SC210A Concentrator. Water extracts were freeze-dried using Freeze Dry System (Labconco®, Freezone 4.5). TLC was carried out on C18 silica gel plates (Analtech, cat. #350016, RP18 w/UV254, 150 μm). The isolated compounds were visualized by observing under UV light at 254 or 366 nm, followed by spraying separately with Dragendorff's and/or 1% vanillin-H₂SO₄ spray reagents.

For the preparation of Universal ChromatoRotor, annealed borosilicate glass (non-tempered), expanded PTFE (Teflon®; 100%) customized filter and stainless steel screws (customized) were used.

If it is not specifically pointed out all standard procedures for coating rotor plates with sorbent including, but not limited to: Cleaning and Setting Up the Rotor for Coating, Mixing and Pouring the Recipe, Drying the Sorbent Layer, Air Drying, Oven Drying, Scraping Sorbent Layers, Storage of Coated Rotors are performed according to the Instruction Manual for Chromatotron®, Harrison Research. Inc. (currently T-Squared Technology, Inc.), model 8924 [18] can be used.

If it is not specifically pointed out all standard procedures for coating rotor plates with sorbent including, but not limited to: Installing the Rotor, Plate Saturation, Solvent Addition, Introducing and Eluting the Sample, Fraction Collection, Clean-up and Regeneration of the Sorbent Layer are performed according to the Instruction Manual for Chromatotron® [18].

### Solvent Choice and Solvent Addition

The centrifugal chromatography separation usually requires a solvent system where R_{f} value of compounds are lower compared to regular TLC due to “pushing” effect of centrifugal forces. For optimum separation, solvents that produce an R_{f} in the range 0.2-0.6 using conventional analytical RP-TLC are preferred. A higher R_{f} is acceptable for quick elution. The range of usable solvents extends to water-based solvent mixtures for RP-sorbent. RP-silica gel layers coated with mixtures of Elmer's and silicate glues are not loosened even by 50% aqueous solvents. The equilibrium conditions during centrifugal preparative separation using customized plates, versus the non-equilibrium conditions of standard TLC, will usually cause better resolutions and generally displays unexpected results due to additional centrifugal force. Bands generally are well separated in the customized plate as compared to analytical TLC plate. This effect is most noticeable when using mixtures of solvents with very different polarities, e.g. acetonitrile—water using RP silica gel. The RP TLC results (R_{f} 0.25-0.6) can generally be reproduced by reducing the proportion of the polar solvent. Gradient elution is recommended for most separations. Step gradients, from the batch-wise addition of solvent mixtures with increasing amounts of a polar solvent, may work well.

Preparation of Pre-Coated RP-Rotors

### Recipe 1 for Pre-Coated RP-Rotor (1 mm Plate, Elmer's Glue)

A slurry of silica get C18 (30 g) and solvent mixture (50 mL acetone and 30 mL H₂O) was made in a conical flask (250 mL) by stirring with a spatula in the sonicator. Elmer's glue (2.5 g) was dissolved in 10 mL H₂O and resulted solution was added to the silica gel C18 slurry drop wise under stirring in the sonicator. Following the procedure described on pp. 29-30 of the Instruction. Manual for Chromatotron® [18], 1 mm plate was prepared. Though, using the tape edge around the rotor is not recommended for glue-bond layer, we used this technique without any problem. The rotor was allowed to dry at ambient conditions on open air during 48 h. After air drying, the tape was carefully removed from the edge of the rotor and the rotor was placed in an oven preheated to 70° C. then temperature was slowly raised to ca 100° C. and maintained for about 1 h. The plate was cooled down slowly to avoid cracking.

The plate was inspected and found to be non-uniform in appearance with weak binding between silica gel and glass surface. During the scrapping of the sorbent layer according to the procedure on p. 28 of the Manual [18] the sorbent layer cracked and felt off from the glass surface in several places. When attempting to wash the rotor with acetone in the Chromatotron, almost all the sorbent layer fell off.

Conclusion: The recipe containing only Elmer's glue did not work.

### Recipe 2 for Pre-Coated RP-Rotor (2 mm Plate, Silicate Glue)

A slurry of silica gel C18 (60 g), UV254 indicator (0.9 g), UV366 indicator (0.6 g), and solvent mixture (60 mL acetonitrile and 30 mL H₂O) was made in a conical flask (250 mL) by stirring with a spatula in the sonicator. The silicate glue (2 g) was dissolved in 10 mL H₂O and the resulting solution was added to the silica gel C18 slurry drop wise under stirring in the sonicator. Following the procedure described on pp. 29-30 of the Instruction Manual for Chromatotron® [18], 2 mm plate was prepared using tape around the edge of the rotor. The rotor was allowed to dry at ambient conditions on open air during 48 h. After air drying, the tape was carefully removed from the edge of the rotor and the rotor was placed in an oven preheated to 70° C. then temperature was slowly raised to ca 100° C. and maintained for about 1 h. The plate was cooled down slowly to avoid cracking.

The plate was inspected and found to be soft and flexible, and no binding was achieved.

Conclusion: The recipe containing silicate glue alone did not work.

### Recipe 3 for Pre-Coated RP-Rotor (1 mm Plate, Elmer's and Silicate Glues)

A slurry of silica gel C18 (35 g) and solvent mixture (40 mL acetonitrile and 10 mL H₂O) was made in a conical flask (250 mL) by stirring with a spatula in the sonicator. Elmer's glue (4 g) was dissolved in 10 mL solvent mixture (5 mL acetonitrile and 5 mL H₂O) and resulted solution was added to the silica gel C18 slurry drop wise under stirring in the sonicator. The silicate glue (0.5 g) was dissolved in 5 mL H₂O and resulted solution was added to the silica gel C18 slurry drop wise under stirring in the sonicator. Following the procedure described on pp. 29-30 of the Instruction Manual for Chromatotron® [18], 1 mm plate was prepared using tape around the edge of the rotor. The rotor was allowed to dry at ambient conditions on open air during 48 h. After air drying, the tape was carefully removed from the edge of the rotor and the rotor was placed in an oven preheated to 70° C. then temperature was slowly raised to ca 100° C. and maintained for about 1 h. The plate was cooled down slowly in the oven by decreasing the temperature gradually to avoid cracking.

The plate was visually inspected and found to have good binding of the silica gel particles and between the silica gel layer and the glass surface. During the scrapping of the sorbent layer according to the procedure on p. 28 of the manual [18] the sorbent layer did not crack. There were only few holes? on the solid sorbent surface. This is probably due to weak binding of sorbent with glass rotor in few areas. The rotor was washed with acetone (100 mL), no sorbent layer was fallen off.

Conclusion: The recipe containing both Elmer's and silicate glues works well, but required minor adjustment. No UV visualization of chromatography process was possible, however, due to absence of fluorescent indicators.

### Recipe 4 for Pre-Coated RP-Rotor (2 mm Plate, Elmer's and Silicate Glues) (See Photos 1-6)

A slurry of silica gel C18 (45 g), UV254 indicator (0.45 g), UV366 indicator (0.45 g), and solvent mixture (50 mL acetonitrile and 20 mL H₂O) was made in a conical flask (250 ml) by stirring with a spatula in the sonicator. Elmer's glue (5.5 g) was dissolved in 10 mL solvent mixture (5 mL acetonitrile and 5 mL H₂O) and resulted solution was added to the silica gel C18 slurry drop wise under stirring in the sonicator. The silicate glue (1 g) was dissolved in 10 mL H₂O and resulted solution was added to the silica gel C18 slurry drop wise under stirring in the sonicator. Following the procedure described on pp. 29-30 of the Instruction Manual fir Chromatotron® [18], 2 mm plate was prepared using tape around the edge of the rotor. The rotor was allowed to dry at ambient conditions on open air during 48 h. After air drying, the tape was carefully removed from the edge of the rotor and the rotor was placed in an oven preheated to 70° C. then temperature was slowly raised to ca 100° C. and maintained for about 1 h. The plate was cooled down slowly to avoid cracking. The plate was visually inspected and found to have good binding of the silica gel particles and between silica gel layer and the glass surface. During the scrapping of the sorbent layer according to the procedure on p. 28 of the Manual [18] the sorbent layer didn't crack. There were only few holes on the solid sorbent surface. The rotor was washed with acetone (100 mL), no sorbent layer was fallen off.

Conclusion: The recipe containing both Elmer's and silicate glues works well. UV visualization of chromatography process is possible due to the presence of fluorescent indicators.

### Recipe 5 for Pre-Coated RP-Rotor (1 mm Plate, Elmer's and Silicate Glues)

A slurry of silica gel C18 (40 g), UV254 indicator (0.4 g), UV366 indicator (0.4 g), and solvent mixture (40 mL acetonitrile and 20 mL H₂O) was made in a conical flask (250 mL) by stirring with a spatula in the sonicator. Elmer's glue (5 g) was dissolved in 10 mL solvent mixture (5 mL acetonitrile and 5 mL H₂O) and resulted solution was added to the silica gel C18 slurry drop wise under stirring in the sonicator. The silicate glue (0.8 g) was dissolved in 10 mL H₂O and resulted solution was added to the silica gel C18 slurry drop wise under stirring in the sonicator. Following the procedure described on pp. 29-30 of the Instruction Manual for Chromatotron® [18], 1 mm plate was prepared using tape around the edge of the rotor. “The slurry was carefully poured onto the glass surface of the rotor when slowly rotating it manually. Then, the slurry was allowed to distribute through the surface by gravitational force, no extra forces or moves.” The rotor was allowed to dry at ambient conditions on open air during 48 h. After air drying, the tape was carefully removed from the edge of the rotor and the rotor was placed in an oven preheated to 80° C. then temperature was slowly raised to ca 100° C. and maintained for about 1 h. The plate was cooled down slowly to avoid cracking.

The plate was visually inspected and found to have good binding of the silica gel particles and between silica gel layer and the glass surface. During the scrapping of the sorbent layer according to the procedure on p. 28 of the Manual [18] the sorbent layer didn't crack. There were no hollows on the solid sorbent surface. The rotor was washed with acetone (100 mL), no sorbent layer was fallen off.

Conclusion: The recipe containing both Elmer's and silicate glues works very well. No additional moves or forces except gravitational during distribution of the slurry through the rotor surface, provide strong binding and uniformity of the sorbent layer. UV visualization of chromatography process is possible due to the presence of fluorescent indicators.

### Recipe 6 for Pre-Coated RP-Rotor (4 mm Plate, Elmer's and Silicate Glues)

A slurry of silica gel C18 (100 g), UV254 indicator (1 g), UV366 indicator (1 g), and solvent mixture (100 mL acetonitrile and 40 mL H₂O) was made in a conical flask (500 mL) by stirring with a spatula in the sonicator. Elmer's glue (11 g) was dissolved in 15 mL H₂O and resulted solution was added to the silica gel C18 slurry drop wise under stirring in the sonicator. The silicate glue (2 g) was dissolved in 10 mL H₂O and resulted solution was added to the silica gel C18 slurry drop wise under stirring in the sonicator. Following the procedure described on pp. 29-30 of the Instruction Manual for Chromatotron® [18], 4 mm plate was prepared. Though, using the tape edge around the rotor is not recommended for glue-bond layer, we used this technique without any problem. Also, no bumping, shaking or tilting was performed as recommended. The slurry was carefully poured onto the glass surface of the rotor when slowly rotating it manually. Then, the slurry was allowed to distribute through the surface by gravitational force, no extra forces or moves. The rotor was allowed to dry at ambient conditions on open air during 48 h. After air drying, the tape was carefully removed from the edge of the rotor and the rotor was placed in an oven preheated to 80° C. then temperature was slowly raised to ca 100° C. and maintained for about 1 h. The plate was cooled down slowly to avoid cracking.

The plate was inspected and found to be uniform in appearance with strong binding between both silica gel particles and silica gel layer with glass surface. During the scrapping of the sorbent layer according to the procedure on p. 28 of the Manual [18] the sorbent layer didn't crack. There were no hollows on the solid sorbent surface. The rotor was washed with acetone (200 mL), no sorbent layer was fallen off.

Conclusion: The recipe containing both Elmer's and silicate glues works very well. No additional moves or forces except gravitational during distribution of the slurry through the rotor surface, provide strong binding and uniformity of the sorbent layer. UV visualization of chromatography process is possible due to the presence of fluorescent indicators.

### Recipe 7 for Pre-Coated RP-Rotor (2 mm Plate, Elmer's and Silicate Glues)

A slurry of silica gel C18 (50 g), UV254 indicator (0.85 g), UV366 indicator (0.5 g), and solvent mixture (50 mL acetonitrile and 20 mL H₂O) was made in a conical flask (250 mL) by stirring with a spatula in the sonicator. Elmer's glue (6 g) was dissolved in 10 mL H₂O and resulted solution was added to the silica gel C18 slurry drop wise under stirring in the sonicator. The silicate glue (1 g) was dissolved in 10 mL H₂O and resulted solution was added to the silica gel C18 slurry drop wise under stirring in the sonicator. Following the procedure described on pp. 29-30 of the Instruction Manual for Chromatotron® [18], 2 mm plate was prepared. Though, using the tape edge around the rotor is not recommended for glue-bond layer, we used this technique without any problem. Also, no bumping, shaking or tilting was performed as recommended. The slurry was carefully poured onto the glass surface of the rotor when slowly rotating it manually. Then, the slurry was allowed to distribute through the surface by gravitational force, no extra forces or moves. The rotor was allowed to dry at ambient conditions on open air during 48 h. After air drying, the tape was carefully removed from the edge of the rotor and the rotor was placed in an oven preheated to 80° C. then temperature was slowly raised to ca 100° C. and maintained for about 1 h. The plate was cooled down slowly to avoid cracking.

The plate was inspected and found to be uniform in appearance with strong binding between both silica gel particles and between the silica gel layer and the glass surface. During the scrapping of the sorbent layer according to the procedure on p. 28 of the Manual [18] the sorbent layer didn't crack. There were no hollows on the solid sorbent surface. The rotor was washed with acetone (100 mL), no sorbent layer was fallen off.

Conclusion: The recipe containing both Elmer's and silicate glues works very well. No additional moves or forces except gravitational during distribution of the slurry through the rotor surface, provide strong binding and uniformity of the sorbent layer. UV visualization of chromatography process is possible due to the presence of fluorescent indicators.

### Recipe 8 for Pre-Coated RP-Rotor (1 mm Plate, Elmer's and Silicate Glues)

A slurry of silica gel C8 (45 g), UV254 indicator (0.8 g), UV366 indicator (0.45 g), and solvent mixture (50 mL acetonitrile and 2.0 mL H₂O) was made in a conical flask (250 mL) by stirring with a spatula in the sonicator. Elmer's glue (5.5 g) was dissolved in 10 mL H₂O and resulted solution was added to the silica gel C8 slurry drop-wise under stirring in the sonicator. The silicate glue (1 g) was dissolved in 10 mL H₂O and resulted solution was added to the silica gel C8 slurry drop wise under stirring in the sonicator. Following the procedure described on pp. 29-30 of the Instruction Manual for Chromatotron® [18], 1 mm plate was prepared. Though, using the tape edge around the rotor is not recommended for glue-bond layer, we used this technique without any problem. Also, no bumping, shaking or tilting was performed as recommended. The slurry was carefully poured onto the glass surface of the rotor when slowly rotating it manually. Then, the slurry was allowed to distribute through the surface by gravitational force, no extra threes or moves. The rotor was allowed to dry at ambient conditions on open air during 48 h. After air drying, the tape was carefully removed from the edge of the rotor and the rotor was placed in an oven preheated to 80° C. then temperature was slowly raised to ca 100° C. and maintained for about 1 h. The plate was cooled down slowly to avoid cracking.

The plate visually looked very good and solid by tactile sensation. Strong binding between both silica gel particles and silica gel layer with glass surface was achieved. During the scrapping of the sorbent layer according to the procedure on p. 28 of the Manual [18] the sorbent layer didn't crack. There were no hollows on the solid sorbent surface. The rotor was washed with acetone (100 mL), no sorbent layer was fallen off.

Conclusion: The recipe containing both Elmer's and silicate glues works very well. No additional moves or forces except gravitational during distribution of the slurry through the rotor surface, provide strong binding and uniformity of the sorbent layer. UV visualization of chromatography process is possible due to the presence of fluorescent indicators.

### Testing Stability of Pre-Coated RP-Rotors

Several 1, 2 and 4 mm pre-coated RP-rotors were prepared following recipes 5-7, as shown in Table 1. Each of pre-coated RP-rotors was mounted on Chromatotron instrument, rotated for an hour without solvents, and then washed with an organic solvent (acetone) to remove excess of binder, followed by washing for an hour with aqueous based solvent mixture (10% water in MeeN) intent to use for real time separation and purification work. After one hour, solvents were stopped and rotors were dried with continuous rotation. The semi-dried rotors were left on the Chromatotron overnight. The next day the rotors were tested again by eluting with aqueous based solvents for a few hours. Rotors were removed after drying and then activated in an oven (100° C., for 2 h). Each activated pre-coated RP-rotor was examined and the recipe that produced the best rotor was selected for further preparation of additional rotors with different thickness.

### Separation and Purification of Mixtures Using RP Coated Rotors.

Experiment 1 (Separation of Sampangine and Imbiline).

A 1 mm RP coated rotor, prepared according to recipe 5, was installed to Chromatotron instrument and saturated with 50 mL of acetonitrile. Mixture of sampangine (1) and imbiline (2) (100 mg) was dissolved in a minimum amount of chloroform and introduced into the plate in a regular way. Chromatography was carried out with the solvent mixture (CH₃CN:H₂O; 8:2). Fraction Collector was used for automatic collection of the eluate. Two separate moving bands of yellow (sampangine) and red (imbiline) color were visually observed during chromatography. Chromatography was stopped when colorful bands were eluted out with approximately 120 mL of the solvent mixture. Fractions collected were analyzed by RP-TLC (using MeCN:H₂O; 9:1 as solvent system) and pooled accordingly. After combining appropriate fractions and removing the solvents 35 mg of 1, 42 mg of 2 and 9 mg of the mixture 1 and 2 were obtained as solid materials. Their identity was confirmed by co-TLC with authentic samples.

Conclusion: Separation was quick and effective. After cleaning-up RP coated rotor didn't change visually. The separation procedure of mixture 1 and 2 was repeated using the same 1 mm RP coated rotor. No degradation was observed when rotor was used repeatedly.

### Experiment 2 (Separation of Epicatechin and Procyanidin B2)

A 2 mm RP coated rotor, prepared according to Recipe 7, was installed to Chromatotron instrument and saturated with 100 mL of chloroform. The fraction from the plant extract containing epicatechin (3) and procyanidin B2 (4) (133 mg) was dissolved in a minimum amount of chloroform-methanol mixture and introduced into the plate in a regular fashion. Chromatography was started with EtOAc (approx. 150 mL) and then, carried out with the solvent mixture (2% MeOH in EtOAc). Fraction Collector was used for automatic collection of the dilate. Two dark separated moving bands were visually observed under UV lamp during chromatography. Chromatography was stopped after the bands were eluted out with approximately 300 mL of the solvent mixture. Fractions collected were analyzed by TLC (using CHCl₃ MeOH; 7:3 solvent system) and pooled accordingly. After combining appropriate fractions and drying 51 mg of 3, 18 mg of 4 and 17 mg of the mixture 3 and 4, and 39 mg of combined residues were obtained as solid materials. The identity of the individual compounds was confirmed by co-TLC with authentic samples. The plate was washed out with the solvent mixture MeOH:H₂O (1:1).

Conclusion: Separation was quick and effective. After cleaning-up, there is no change visually observed for the RP coated rotor, and no degradation was detected as well.

### Preparation of Universal ChromatoRotors of Design 2.

### ChromatoRotor 1 (4 mm).

As an example, several ChromatoRotors 1, 3, 4 and 6 mm were made based on Design 2. FIGS. 4 and 5 represent sectional views of the separating device (ChromatoRotor) containing a 4 mm layer of a sorbent material. A lower annular plate/disc 2 and a corresponding upper annular p(ate/disc 3 were made of 3 mm thick borosilicate glass with outer diameter 240 mm, so they precisely fit Chromatotron® or Cyclograph® instruments. Transparent glass ensures visual observation of a chromatographic separation process. An upper annular plate/disc 3 has an inner opening with diameter 80 mm and serves the purpose to introduce solvents/samples into the sorbent layer 1 sandwiched between lower (2) and upper (3) plates. The different sorbents normal SiO₂ and reversed phase SiO₂ were used for filling up the discs. Fluorescent indicators like UV254 and UV366 were added to a sorbent media in amount 0.5-1% to ensure visible control of chromatographic separation under UV light with light blue and deep blue backgrounds, respectively. In order to retain a layer of a sorbent material from moving outside a porous filter 4, allowing only liquids to pass through, is arranged at the outer edge of an annular separation device. The porous filter 4 was made of sintered Teflon®. The channels 1 mm depth along outer perimeters of lower 2 and upper 3 plates were made at the distance 12 mm from the outer edge of plates. The porous filter 4 as a narrow strip (3 mm thick and 6 mm height) fits tightly into these channels and secures the sorbent media within a separating device. Both discs 2 and 3 are fixed together by means of three screws 6. Three additional support elements 5 are arranged between discs 2 and 3 to prevent a collapse of plates 2 and 3 because a porous filter 4 is made of flexible material. Use of additional support elements 5 also ensures the constant thickness between lower 2 and upper 3 plates which is crucial for a total balance of the separating device during rotation. The support element 5 has a washer type shape with diameter 12 mm and height 4 mm to keep a constant distance 4 mm between the surfaces of discs 2 and 3. Screw 6 is coming through a hollow part of the support element 5, so this combination does not prevent a normal course of a chromatographic process. The support element 5 was made of Teflon®. Three screws 6 made of stainless steel were used to secure the disposition of lower 2 and upper 3 plates.

The slurry of 65 g reversed phase C18 SiO₂ in 200 mL of acetonitrile was poured by small portions and slow rotation into the space between discs 2 and 3. A slow rotation is needed to ensure consistent and tight packing of a sorbent material. The sorbent was packed up to the level about 5 mm from the inner edge of upper plate 3. After stopping rotation still wet sorbent media was secured from falling outside by round cotton strip which completely isolated silica gel within the discs space. After drying under vacuum in the desiccator the separating device (ChromatoRotor) was ready for use in Chromatotron®. The silica gel rotor can be reused many times after regeneration. If needed, silica gel can be removed and replaced with any other sorbent appropriate for the chromatographic separation. It can be done by removing dried sorbent mechanically or by demounting the rotor, which gives a full access to a sorbent media 1. Design 2 allows to change easily a capacity of the given separation element by replacing a porous filter 4 and support elements 5 with ones of appropriate thickness.

### ChromatoRotor 2 (1 mm).

The ChromatoRotor was prepared according to the procedure described for the ChromatoRotor 1 but the porous filter 4 as a narrow strip (3 mm thick and 2 mm height), three support elements 5 (height 1 mm) and three screws 6 were used to provide the total thickness of the sorbent layer 1 equal to 1 mm. The slurry of 25 g reversed phase C18 SiO₂ in 75 mL of chloroform was poured by small portions and slow rotation into the space between discs 2 and 3.

### ChromatoRotor 3 (3 mm).

The ChromatoRotor was prepared according to the procedure described for the ChromatoRotor 1 but the porous filter 4 as a narrow strip (3 mm thick and 6 mm height), six support elements 5 (height 3 mm) and six screws 6 were used to provide the total thickness of the sorbent layer 1 equal to 3 mm. The slurry of 40 g normal phase SiO₂ (doped with fluorescent indicators UV254 and UV366 in amount 0.5% each) in 100 mL of chloroform was poured by small portions and slow rotation into the space between discs 2 and 3. A sintered Teflon strip (height 3 mm) was used as inner filter to secure silica gel within the discs space.

### ChromatoRotor 4 (6 mm).

The ChromatoRotor was prepared according to the procedure described for the ChromatoRotor 1 but the porous filter 4 as a narrow strip (3 mm thick and 8 mm height), three support elements 5 (height 6 mm) and three screws 6 were used to provide the total thickness of the sorbent layer 1 equal to 6 min. 100 g reversed phase C18 SiO₂ (doped with fluorescent indicators UV254 and UV366 in amount 0.5% each) in dry form was poured by small portions and slow rotation into the space between discs 2 and 3. A strip of filter paper (height 6 mm) was used as inner filter to secure silica gel within the rotor space.

### Test of ChromatoRotors of Design 2 for Stability

Several 1, 3, 4 and 6 mm ChromatoRotors according to Design 2 were tested for stability. For that purpose several discs were filled with normal silica gel, RP silica gel and alumina, respectively. Each of rotors was mounted on Chromatotron instrument, rotated for an hour without solvents, and then washed with an organic solvent (acetonitrile), followed by washing for an hour with aqueous based solvent mixture (50% water in MeCN) intent to use for real time separation and purification work. After about one hour, solvent supply was stopped and rotors were dried under vacuum in a desiccator (so the drying is very fast). The next day the rotors were tested again by eluting with aqueous based solvents for few hours. ChromatoRotors were removed after drying under vacuum. Each rotor was examined and no defects were found.

### Separation and Purification of Mixtures/Extracts Using ChromatoRotors.

Experiment 1 (Separation of Amorphaquinone).

A 4 mm ChromatoRotor of design 2 was packed by slurry of normal silica gel (65 g) doped with UV254 and UV366 fluorescent indicators (0.5% each) in chloroform. The solvent was removed under the vacuum in a desiccator. The rotor was installed into Chromatotron® instrument. Sample (column fraction AS-C-12 (460 mg) from Abrus schimperii EtOH extract) was dissolved in 3.5 mL CHCl₃ and 5 drops MeOH with continuous sonication. Solution was added to the ChromatoRotor via pump, previously saturated with CH₂Cl₂ (100 mL) and elution was started with CH₂Cl₂ (50 mL). Bands visible under UV light (254 nm) were moving fast (due to the presence of trace volume of MeOH), so CH₂Cl₂ was replaced with n-hexane (100 mL). After that chromatography continued with CH₂Cl₂ (150 mL) and then CH₂Cl₂-MeOH: 99.5-0.5 (200+300+300 mL=800 mL total). A total of 66 test tubes (1-66) were collected (15 mL each). Finally, the rotor was washed with MeOH (300 mL) for regeneration which was collected in a conical flask.

Based on TLC analyses, combination of fractions was done as follows:

| | | Total weight after drying |
|---|---|---|
| Testube/Conical flask | Fraction code | (mg) |
| 3-9 | AS-C-12-A | 29 |
| 10-18 | AS-C-12-B | 100 |
| 19-34 | AS-C-12-C | 95 |
| 35-66 | AS-C-12-D | 98 |
| 67 (300 mL in flask) | AS-C-12-E | 118 |

Compound (5) (FIG. 3) was identified from the fraction A as amorphaquinone (29 mg).

Experiment 2 (Separation of Banistenosides A and B).

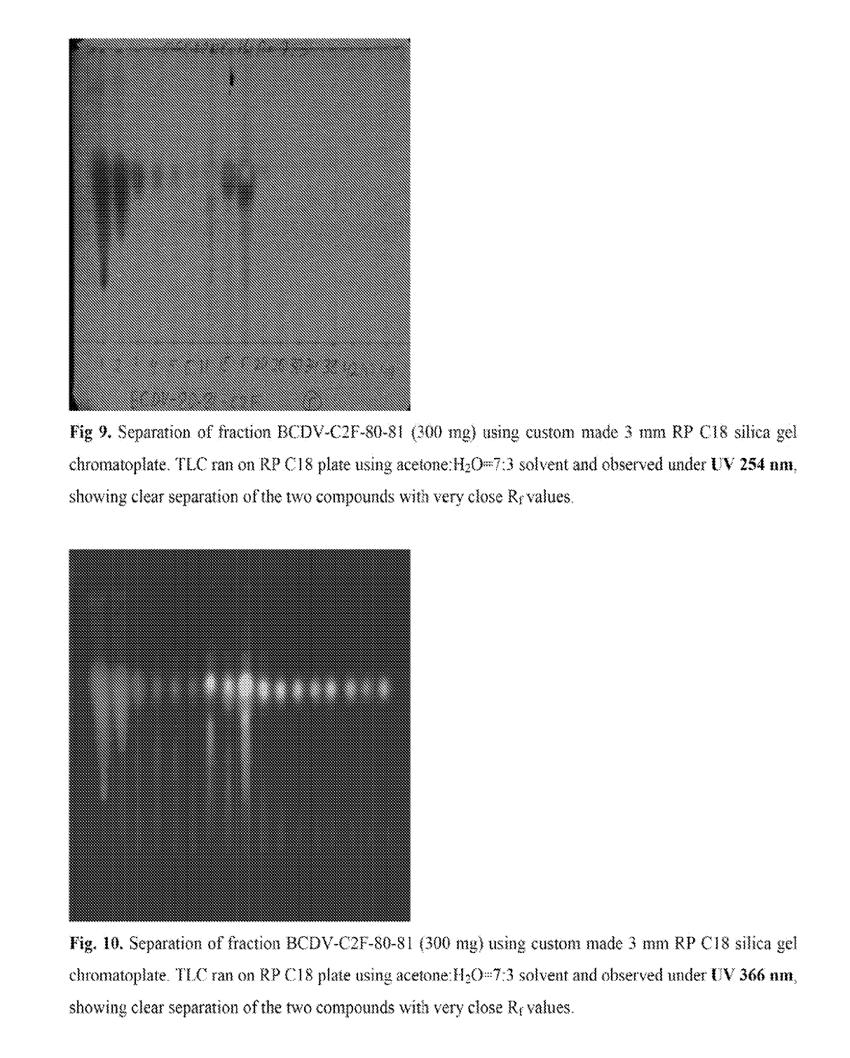

A RP C18 TLC analysis of an alkaloidal fraction from Banisteriopsis caapi water extract revealed two polar compounds with very close R_{f} values. Column chromatography on RP C18 gave only a mixture of two compounds. So, centrifugal chromatography using custom 3 mm disc was employed to separate both compounds in pure form. 3 mm ChromatoRotor of design 2 was packed by slurry of RP C18 silica gel (45 g) doped with UV254 and UV366 fluorescent indicators (0.5% each) in acetone. The solvent was removed under the vacuum in a desiccator. The rotor was installed into Chromatotron® instrument and saturated with a solvent 20% H₂O in acetone. Concentrated methanol-water solution of column fraction C2F-80-81 (300 mg) from B. caapi water extract containing two very polar alkaloidal glycosides (they give a single spot on normal silica gel TLC and don't move from the baseline by methanol eluent) was applied into 3 mm ChromatoRotor. The rotor was dried under the vacuum and eluted with 20% H₂O in acetone. Two moving fluorescent bands were observed by long- and short-wave UV light during chromatography separation and they were eluted as pure compounds from ChromatoRotor. The rotor was washed with 50% H₂O in acetone first, then with MeOH for regeneration. 20 mL fractions were collected, pooled based on TLC analysis (FIGS. 9 and 10) and combined accordingly. First compound (banistenoside A [27]) eluted from fractions 1-6, while the second compound (banistenoside B [271) eluted from fractions 20-49. Combined fractions were first concentrated under reduced pressure, then water was removed by Freeze Dry System (−44° C., 1.6 Pa). Banistenosides A (6) (48 mg) and B (7) (26 mg) (FIG. 3) were isolated as white powders (>95% purity by NMR) together with their mixture (120 mg) and mixture of impurities (92 mg).

Experiment 3 (Separation of Saponin Glycosides).

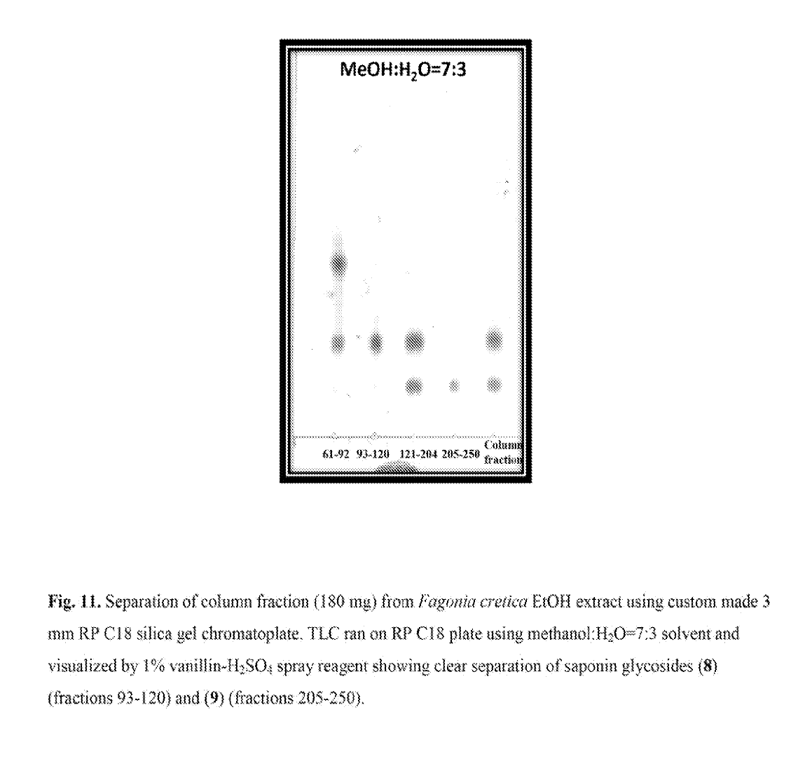

A 3 mm ChromatoRotor of design 2 was packed by slurry of RP C18 silica gel (45 g) doped with UV254 and UV366 fluorescent indicators (0.5% each) in acetonitrile. The solvent was removed under the vacuum in a desiccator. The rotor was installed into Chromatotron® instrument and saturated with a solvent 60% H₂O in MeOH. Concentrated methanol solution of column fraction (180 mg) from Fagonia cretica EtOH extract containing mostly two very polar saponin glycosides (they show a single spot on silica gel TLC) was applied on a 3 mm custom plate. The rotor was dried under vacuum and eluted consecutively with 60% H₂O in MeOH, then with 50% H₂O in MeOH, and finally with 40% H₂O icy MeOH. The rotor was washed with MeOH for regeneration. 2.0 mL fractions were collected, pooled based on TLC analysis (FIG. 11) and combined accordingly. Combined fractions were first concentrated under reduced pressure, then water was removed by Freeze Dry System (−44° C., 1.6 Pa). Saponin glycosides (8) (26 mg) and (9) (34 mg) (FIG. 1) were isolated as white powders (>95% purity by NMR) together with their mixture (115 mg).

### REFERENCES

1. Hopf, P. P. 1947. Radial Chromatography in Industry. Industrial and Engineering Chemistry 39(8), 938-940.
2. Magnuson, D. V. and McDonald, H. J. 1961. Chromatographic separation apparatus. U.S. Pat. No. 2,986,280.
3. Lowery, J. A. 1963. Rapid centrifugal chromatography. U.S. Pat. No. 3,113,103.
4. Lowery, J. A. and Cassidy, J. E. 1964. Centrifugal paper chromatography and some of its applications. Journal of Chromatography 13, 467-474.
5. Deyl, Z., Rosmus, J. and Pavlicek, M. 1964. Centrifugal chromatography. Chromatographic Reviews 6, 19-52.
6. Heftmann, E., Krochta, J. M., Farkas, D. F., Schwimmer, S. 1972. The chromatofuge, an apparatus for preparative rapid radial column chromatography. Journal of Chromatography 66, 365-369.
7. Hostettmann, K., Hostettman-Kaldas, M., Sticher, O. 1980. Rapid preparative separation of natural products by centrifugal thin-layer chromatography. Journal of Chromatography 202, 154-156.
8. Hunter, I. R., Heftmann, E. 1983. Isolation of glycoalkaloids with the Chromatotron and their determination by high-performance liquid chromatography. Journal of Liquid Chromatography 6, 281-289.
9. Sekiya, S., Tsuji, K. and Yamanaka, M. 1979. Rapid separation and determination of nonionic substances in detergents by centrifugal chromatography. Yukagaku 28(7) 497-500.
10. Chen, S. and Wang J. 1982. Study on the separation of isomers and synthetic products by chromatotron. Huaxue Tongbao 10, 591-593.
11. Fukuda, T., Takahashi H. 1978. Centrifugal liquid chromatograph. U.S. Pat. 4,077,886.
12. Thompson, D. W. 1968. Apparatus and method for performing a continuous chromatographic analysis. U.S. Pat. No. 3,417,548.
13. Tuthill, E. J., Terre, B., Fedelem, J. 1970. Apparatus for continuous chromatography. U.S. Pat. No. 3,527,350.
14. Giltrow, J. 1971. Preparative separation of fluid samples. U.S. Pat. No. 3,617,557.
15. Liberti, P. A. 1968. Centrifugal chromatography and electrophoresis device. U.S. Pat. No. 3,395,093.
16. Harrison, S. 1979. Preparative centrifugal chromatography device. U.S. Pat. No. 4,139,458.
17. Meszaros S., Verzar-Petri G., Nyiredy-Mikita K., Tyihak E., Nyiredy S., Meier B., Sticher O., Dallenbach-Toelke K. 1979. Planar centrifugal chromatography device. U.S. Pat. No. 4,678,570.
18. Chromatotron®, 7924T, Operation manual. T-Squared Technology, Inc., USA. www.tsqtech.com.
19. Cyclograph®, Operation manual. Analtech Inc., USA. http://www.ichromatography.com/cyclograph.html.
20. Muhammad, I., Waterman, P. G. J. Chem. Soc. Chem. Commun., 1984, 1280-1281.
21. Muhammad, I., Waterman, P. G. J. Nat. Prod. 1985, 48(4), 571.
22. Muhammad, I., Waterman, P. G. J. Nat. Prod. 1988, 51(4), 719-724.
23. Samoylenko, V., Dunbar, D. C., Gafur, M. A., Khan, S. I., Ross, S. A., Mossa, J. S., El-Feraly, F. S., Tekwani, B. L., Bosselaers, J., Ilias Muhammad, I. Phytotherapy Research, 2008, 22, 1570-1576.
24. Samoylenko, V., Ashfaq, M. K., Jacob, M. R., Tekwani, B. L., Khan, S. I., Manly, S. P., Joshi, V. C., Walker, L. A., Muhammad, I. Journal of Natural Products, 2009, 72 (1), 92-98.
25. Samoylenko, V., Khan, S. I., Jacob, M. R., Tekwani, B. L., Walker, L. A., Hufford, C. D., Muhammad, I. Natural Products Communication, 2009, 4 (2), 185-192.
26. Samoylenko, V., Melissa R. Jacob, M. R., Khan, S. I., Zhao, J., Tekwani, B. L., Midiwo, J. O., Walker, L. A., Muhammad, I. Natural Products Communication, 2009, 4(6), 791-796.
27. Samoylenko V., Rahman, M. M., Tekwani, B. L., Tripathi, L. M., Wang, Y-.H., Khan, S. I., Khan, I. A., Miller, L. S., Joshi, V. C., Muhammad. I. Journal of Ethnopharmacology, 2010, 127, 357-367.

We claim:

1. A disc adapted for use in centrifugal chromatography comprising a rotor having a sorbent layer on one surface of the rotor wherein the sorbent layer is affixed to the rotor surface by a mixture of two or more binders to bind the sorbent to the rotor surface.

2. The disc of claim 1, where the sorbent is a reverse phase solid silica gel including RP-silica gel modified with functional groups and/or chiral groups.

3. The disc of claim 1, wherein the binders are not leached by a water based vehicle.

4. The disc of claim 1, wherein the binders are Elmer's glue, silicate glue, carpenters wood glue (Elmer's), clear acrylic latex siliconized sealants, silicone in caulking tubes etc.

5. The disc of claim 1, wherein at least one binder preferably binds the sorbent particles among themselves and least one binder preferable binds the sorbent with the rotor surface.

6. The disc of claim 1, wherein the binder mixture is a mixture of Elmer's glue and silicate glue.

7. The disc of claim 1, where the sorbent comprises at least one fluorescent indicator.

8. The disc of claim 1, where the sorbent layers are of different thickness.

9. A chromatographic separation system (i.e., a ChromatoRotor) comprising a binder free sorbent packed between two discs wherein the discs are attached to each other and wherein the binder free sorbent is supported from moving out of the two discs by a porous filter which allows only liquids or eluents to pass through.

10. The system of claim 9, wherein the sorbent comprises any sorbent appropriate for chromatography including but not limited to normal silica gel (SiO₂) including silica gel modified with functional groups and/or chiral groups, reversed phase silica gel including RP-silica gel modified with functional groups and/or chiral groups, alumina, polyamide, Sephadex, resins, etc.

11. The system of claim 9, wherein the sorbent further comprises at least one fluorescent indicator.

12. The system of claim 9, where the system is of different thickness.

13. The system of claim 9, where the top disc is of transmittable or semi-transmittable material.

14. The system of claim 9, where the porous filter comprises of thin porous metal, plastic, fiber, glass or other chemically resistant materials.

15. The system of claim 9, where the porous filter comprises of sintered Teflon®.

16. A method for centrifugal chromatographic separation of the component of a mixture using the disc according to claim 1.

17. The method of claim 16, wherein the mixture comprises at least one polar organic compound.

18. A method for centrifugal chromatographic separation of the component of a mixture using the system according to claim 9.

19. The method of claim 18, wherein the mixture comprises at least one polar organic compound.
